(19) United States
(12) Patent Application Publication
(10) Pub. No.: US 2013/0189661 A1
(43) Pub. Date: Jul. 25, 2013

(54) SCORING HUMOR REACTIONS TO DIGITAL MEDIA

(71) Applicant: AFFECTIVA, INC., Waltham, MA (US)

(72) Inventors: Rana el Kaliouby, Waltham, MA (US); Avril England, Pleasanton, CA (US); Evan Kodra, Cambridge, MA (US); Rosalind Wright Picard, Newtonville, MA (US)

(73) Assignee: AFFECTIVA, INC., Waltham, MA (US)

(21) Appl. No.: 13/794,948

(22) Filed: Mar. 12, 2013

Related U.S. Application Data
(63) Continuation-in-part of application No. 13/153,745, filed on Jun. 6, 2011.
(60) Provisional application No. 61/609,918, filed on Mar. 12, 2012.
(60) Provisional application No. 61/693,276, filed on Aug. 25, 2012.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.

(51) Int. Cl. G09B 19/00

(52) U.S. Cl. CPC G09B 19/00
USPC 434/236

(57) ABSTRACT

As an individual or a group of individuals view various types of humor, a webcam, using video capture, collects mental state data from the individual or individuals. The webcam data is analyzed to determine physiological data, facial data, and actigraphy data. Further, the direct collection of physiological data—electrodermal activity, heart rate, heart rate variation, skin temperature, and respiration—from an individual or individuals complements the webcam data. Analysis of this mental state data allows for the accurate comprehension of individual humor preferences and allows the individual's humor preferences to be used by the system to recommend humorous material based on these preferences.

### RELATED APPLICATIONS

This application claims the benefit of U.S. provisional patent applications “Scoring Humor Reactions to Digital Media” Ser. No. 61/609,918, filed Mar. 12, 2012 and “Analyzing Humor Reactions to Digital Media” Ser. No. 61/693,276, filed Aug. 25, 2012. This application is also a continuation-in-part of U.S. patent application “Mental State Analysis Using Web Services” Ser. No. 13/153,745, filed Jun. 6, 2011 which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. The foregoing applications are hereby incorporated by reference in their entirety.

### FIELD OF ART

This application relates generally to analysis of mental states and more particularly the scoring of reactions to humorous digital media.

### BACKGROUND

People increasingly spend a tremendous amount of time engaged in viewing and interacting with videos. This consumption includes genres as diverse as education, entertainment, daily news, movies, as well as political forums and debates to name a few. Viewers may watch the video as a stand-alone element on an electronic display, as part of a webpage, or in numerous other contexts. Evaluation of personal response to these videos represents a crucial gauge of content effectiveness across multiple genres; the content may be educational, commercial, entertaining, or political. Currently, viewers may tediously self-rate videos to communicate personal preference. In some cases, viewers may enter a specific number of stars corresponding to a level of like or dislike, while in other cases they may answer a list of questions. While this system of evaluation may be a helpful metric to evaluate specific video segments, even evaluating these specific segments often proves tedious and challenging due to the difficulty of quickly responding to a short clip. Thus, this type of subjective evaluation is neither a reliable nor practical way to evaluate personal response to a whole video, nor is such a subjective system effective for the evaluation of a personal response to a targeted segment of a video. Recommendations based on such a system of star rating or other self-reporting are imprecise, subjective, unreliable, and are further subject to sample-size bias—only a small number of viewers may actually rate the media.

Humorous videos may be an effective medium for delivering messages of various types. But certain types of humor may cause one viewer to dissolve into tears and laughter merely in anticipation of the punch line yet provoke strong feelings of aversion in another viewer. Thus, the importance of determining the effectiveness of differing types of humor on individuals becomes evident. Accurately measuring viewers' responses to types of humor would allow the viewers to be recommended videos which are entertaining, educational, or contain important messages. These recommendations would be based on precise, objective, and reliable evaluations.

### SUMMARY

Analysis of people interacting with the Internet and various media may be performed by deducing mental states through evaluation of facial expressions, head gestures, and physiological signals. This mental state analysis can be used to evaluate people's reactions to humor-related video and media. A computer-implemented method for mental state analysis is disclosed comprising: collecting mental state data of an individual as the individual is exposed to a media presentation; inferring mental states based on the mental state data which was collected wherein the mental states include reactions to multiple types of humor; and analyzing the reactions to the multiple types of humor to identify one or more preferred types of humor.

Multiple types of humor may be included in the media presentation. The media presentation may include a series of videos. The series of videos may represent the multiple types of humor. The method may further comprise categorizing the individual based on the reactions to the multiple types of humor. The method may further comprise clustering the individual with other individuals based on the reactions to multiple types of humor. The other individuals may be exposed to the series of videos. The multiple types of humor may include one of slapstick comedy, romantic comedy, cerebral comedy, raunchy comedy, political comedy, noir comedy, dry comedy, physical comedy, and satirical comedy. The multiple types of humor include one or more of Republican bashing, Democrat bashing, conservative humor, liberal humor, family-rated humor, adult-rated humor, humor involving cats, humor involving dogs, and humor involving babies. The inferring of mental states further may include one or more of a group including frustration, confusion, disappointment, hesitation, cognitive overload, focusing, being engaged, attending, boredom, exploration, confidence, trust, delight, and satisfaction. The method may further comprise identifying one or more persons based on the mental states which were inferred. The identifying one or more persons may include identifying those with similar mental states. The one or more persons may be within a social network. The identifying may be determined based on responses by the individual and the one or more persons to the media presentation. The identifying may further be a function of self-reporting. The identifying may be based on mapping people into clusters. The identifying may include generating a vector of mental state data including one or more of facial data, head movement, body position, and self-report results. The identifying may include determining people with a vector close to the individual. The identifying may include determining people with a vector distant from the individual. The analyzing the reactions to the multiple types of humor may further comprise identifying a type of humor which the individual finds to be funny. The analyzing the reactions to the multiple types of humor may further comprise identifying a type of humor to which the individual is averse. The mental state data may include smiles, laughter, smirks, and grimaces. The mental state data may include head position, up/down head motion, side-to-side head motion, tilting head motion, body leaning motion, and gaze direction. The method may further comprise scoring the media presentation for humor based on the mental state data which was collected. The method may further comprise posting the scoring to a social network page. The method may further comprise using the scoring for introducing people. The method may further comprise making recommendations for other media based on personal preferences of other individuals with similar mental states. The method may further comprise determining which advertisements are shown to the individual. The mental state data may include one of a group comprising physiological data, facial data, and actigraphy data. The physiological data may include one or more of electrodermal activity, heart rate, heart rate variability, skin temperature, and respiration. A webcam may be used to capture one or more of the facial data and the physiological data. The media presentation may include one of a group consisting of a movie, a television show, a web series, a webisode, a video, a video clip, an electronic game, an e-book, and an e-magazine. The method may further comprise analyzing the mental state data to produce mental state information.

In embodiments, a computer-implemented method for mental state analysis may comprise: collecting mental state data of an individual as the individual is exposed to a media presentation; and sending the mental state data, which was collected, for inferring mental states based on the mental state data which was collected wherein the mental states include reactions to multiple types of humor and analyzing the reactions to the multiple types of humor to identify one or more preferred types of humor. In some embodiments, a computer-implemented method for mental state analysis may comprise: receiving mental state data, collected from an individual as the individual is exposed to a media presentation; inferring mental states based on the mental state data which was collected wherein the mental states include reactions to multiple types of humor; and analyzing the reactions to the multiple types of humor to identify one or more preferred types of humor. In embodiments, a computer-implemented method for mental state analysis may comprise: receiving an analysis of reactions to multiple types of humor wherein the analysis is used to identify one or more preferred types of humor based on mental state data collected from an individual as the individual is exposed to a media presentation and wherein mental states are inferred based on the mental state data which was collected; and rendering an output based on the analysis which was received

In embodiments, a computer program product embodied in a non-transitory computer readable medium for mental state analysis may comprise: code for collecting mental state data of an individual as the individual is exposed to a media presentation; code for analyzing the mental state data to produce mental state information; code for inferring mental states based on the mental state data which was collected wherein the mental states include reactions to multiple types of humor; and code for analyzing the reactions to the multiple types of humor to identify one or more preferred types of humor. In some embodiments, a system for mental state analysis may comprise: a memory for storing instructions; one or more processors attached to the memory wherein the one or more processors are configured to: collect mental state data of an individual as the individual is exposed to a media presentation; analyze the mental state data to produce mental state information; infer mental states based on the mental state data which was collected wherein the mental states include reactions to multiple types of humor; and analyze the reactions to the multiple types of humor to identify one or more preferred types of humor.

Various features, aspects, and advantages of numerous embodiments will become more apparent from the following description.

### BRIEF DESCRIPTION OF THE DRAWINGS

The following detailed description of certain embodiments may be understood by reference to the following figures wherein:

FIG. 1 is a flow diagram for analyzing mental state data from a humor perspective.

FIG. 2 is a diagram for capturing facial response to rendering.

FIG. 3 is a diagram representing physiological analysis.

FIG. 4 is a diagram of heart-related sensing.

FIG. 5 is a graphical representation of mental state analysis.

FIG. 6 is an example diagram showing two vectors.

FIG. 7 is an example social network page content.

FIG. 8 is a diagram showing an example graph of humor clustering.

FIG. 9 is a system diagram analyzing mental state data from a humor perspective.

### DETAILED DESCRIPTION

The present disclosure provides a description of various methods and systems for analyzing people's mental states as they view videos, and for using this analysis to determine an individual's or a group of people's preferred type of humor. The humor preferences can be used to recommend other media to viewers based on their reactions to previously viewed videos. The humor preferences can also be used to recommend potential networking connections to viewers; for example, if a viewer prefers humor involving babies, another viewer with similar preferences could be recommended as a networking contact.

Mental state data may be collected from an individual while viewing videos or other digital media presentations. Mental state data may include physiological data from sensors, facial data from a webcam, actigraphy data, and the like. This mental state data may be analyzed to create usable mental state information, including mood analysis along with other mental state information derived or inferred from collected mental state data. This collected information may include measurements of one or more users' frustration, confusion, disappointment, hesitation, cognitive overload, focus, engagement, attention, boredom, exploration, confidence, trust, delight, and satisfaction, among other emotions or cognitive states. All this can be done along with evaluating humor-type reactions. Mental state information may relate to an individual's reaction to specific stimulus—such as a web-provided videos—or may comprise the measurement of a mood, which may relate to a longer period of time and may indicate, for example, a mental state for a day. The results of mental state analysis may be shared over a social network by posting reactions to various forms of comedy on a social media or social network web page. The mental state shared may be an overall reaction or a reaction to a portion of a video or other piece of media.

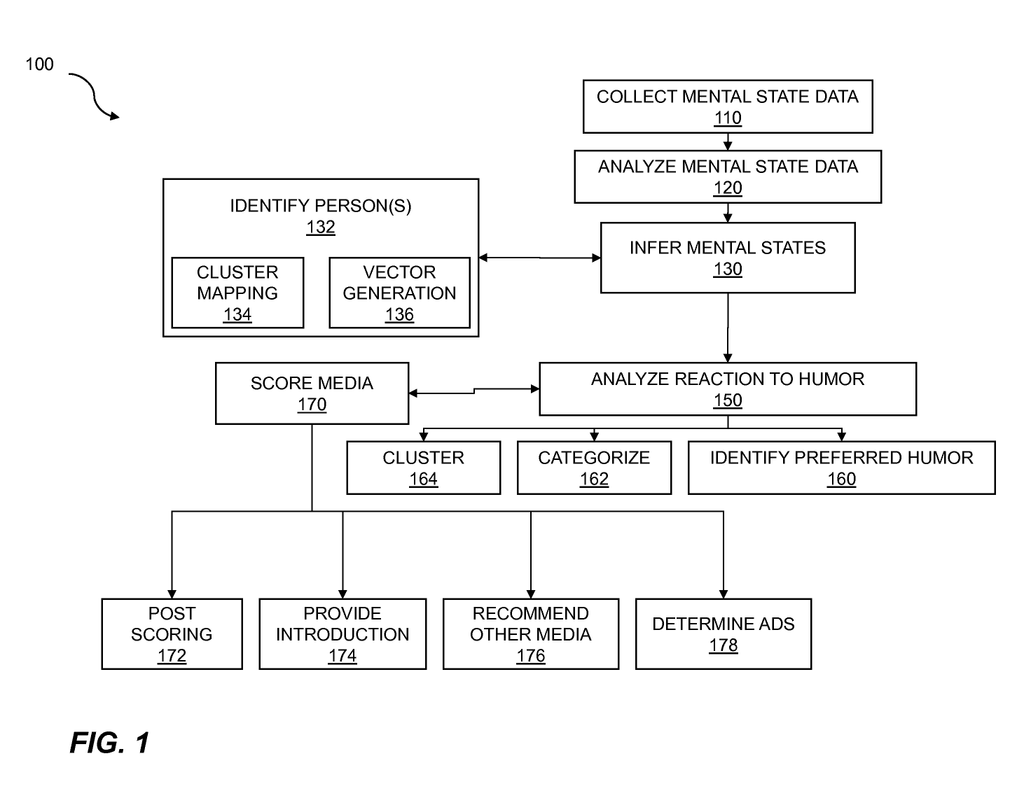

FIG. 1 is a flow diagram for analyzing mental state data from a humor perspective. Flow 100 diagrams a computer-implemented method for mental state analysis. The flow 100 may begin with collecting mental state data 110 of an individual as the individual is exposed to a media presentation. Multiple types of humor may be included in the media presentation. The media presentation may include a series of videos. The series of videos may represent the multiple types of humor such as those articulated below. The media presentation may include one of a group consisting of a movie, a television show, a web series, a webisode, a video, a video clip, an electronic game, an e-book, an e-magazine, and the like. The mental state data may include collecting action units, physiological data, facial data, actigraphy data, and the like. Physiological data may be obtained from video observations of a person. For example, heart rate, heart rate variability, autonomic activity, respiration, skin temperature, and perspiration represent some forms of physiological data which may be observed from the captured video. Alternatively, in some embodiments, a biosensor may be used to capture physiological information as well as accelerometer readings. Permission may be requested and obtained prior to the collection of mental state data 110. A client computer system may collect the mental state data.

The flow 100 may continue with analyzing the mental state data 120 to produce mental state information, particularly mental state information pertinent to analysis of personal reactions to humor and comedy. While mental state data may include raw data such as heart rate, it may also include information derived from the raw data. The mental state data may include smiles, laughter, smirks, and grimaces. The mental state data may include head positions, up/down head motion, side-to-side head motion, tilting head motion, body leaning motion, and gaze direction. The mental state information may include valence and arousal. The mental state information may include the mental states experienced by the individual. Some embodiments may include inferring mental states based on the collected mental state data. The flow 100 may further comprise inferring mental states 130 based on the mental state data which was collected, where the mental states include reactions to multiple types of humor. The mental states may include one of a group consisting of frustration, confusion, disappointment, hesitation, cognitive overload, focusing, being engaged, attending, boredom, exploration, confidence, trust, delight, valence, skepticism, and satisfaction. The mental states may also include happiness, being mirthful, being buoyant, and other states related to enjoying humor. The mental states may further include skepticism, doubt, disgust, and other states related to disliking certain humor. The flow 100 may include identifying one or more persons 132 based on the mental states which were inferred. The one or more identified persons may be within a social network or may be recommended to become part of a social network. The identifying may be based on mapping people into clusters 134. The identifying one or more persons may include identifying those people who evidence similar mental states when exposed to a certain type of humor. The identifying may be determined based on responses to the media presentation. The identifying may be a function of inferred mental states, and may further be a function of self-reporting. The self-reporting may involve responding to questions or rating certain videos. The identifying may include generating a vector 136 of mental state data including one or more of facial data, head movement, body position, and self-report results. The vector or plurality of vectors may describe reactions to humor.

The flow 100 may continue with analyzing people's reactions to the multiple types of humor 150 to identify one or more preferred types of humor 160. The analyzing the reactions to the multiple types of humor may further comprise identifying a type of humor which the individual finds to be funny. The analyzing the reactions to the multiple types of humor may further comprise identifying a type of humor to which the individual is averse. The flow 100 may include a method of categorizing 162 the individual based on the reactions to the multiple types of humor. They may be categorized as liking certain types of humor or disliking other types of humor. The multiple types of humor may include one of slapstick comedy, romantic comedy, cerebral comedy, raunchy comedy, political comedy, noir comedy, dry comedy, physical comedy, and satirical comedy. The multiple types of humor may further include one of Republican bashing, Democrat bashing, Conservative humor, Liberal humor, family-related humor, adult-rated humor, humor involving cats, humor involving dogs, and humor involving babies. The flow 100 may include clustering 164 the individual with other individuals based on reactions to the multiple types of humor. The clustering may be based on one common type of humor or a group of humor types. The other individuals may be exposed to the series of videos that were seen originally by the first individual. The other individuals may be exposed to a subset or a superset of the videos originally seen by the first individual.

The flow 100 may include scoring a media presentation 170 for humor based on the mental state data which was collected. The media presentation may include one or more videos. The flow 100 may include posting the scoring 172 to a social network page. The flow 100 may include using the scoring for introducing 174 people. The flow 100 may include making recommendations for other media 176 based on the personal preferences of other individuals with similar mental states. In some cases, the providing introductions 174 may be part of the identifying persons 132. The flow 100 may include determining advertisements 178 to be shown to an individual.

The identifying may include determining people with a vector close to the individual. Analysis on vectors may be performed to determine similarities. The identifying may include determining people with a vector distant from the individual. In some embodiments, individuals may be exposed to, for example, ten kinds of videos representing different genres of humor. The presentation may include an hour-long reel of fixed-length videos, or it may be a tree-structured presentation where the individual determines media sequence: for example, if an individual expresses preference for a certain type of humor, more videos of that type are queued. Simultaneously, faces may be analyzed for mental state data.

While watching a certain segment of a humorous video—for example, at least x minutes of each video where x may be something like two to three minutes or some other duration depending on the genre of humor—individual video and facial data is obtained. After watching the segment, the viewer can keep watching or click to stop by selecting options such as “Stop, I don't like this one,” “Stop, I have mixed feelings,” or “Stop, I like it but don't have time now.” A vector may be built of the viewer's or viewers' responses; including facial observations, head movement, body position, and click (self-report) data. Multiple similarity measures may be used to accomplish unsupervised clustering—that is, to put each person into one or more groups with other people—such as weighted mean-squared error, Mahalanobis distance, Kullback-Leibler (KL) divergence, symmetric KL-divergence, histogram intersection, rule-based comparisons, and the like. In some cases, hard clustering such as K-means clustering where each person is in one group—may be used. Alternatively, an individual can be assigned membership in multiple cluster groups based on weights such as Expectation-Maximization. For example, people who scowl or pull back from raunchy comedy, who laugh or smile at conservative-friendly political humor, or who smile or lean into cerebral comedy and are neutral toward the other categories, might land in the same cluster. Different numbers of clusters may be formed. A large number of clusters may contain a small number of highly homogenous people. Alternatively a smaller number of clusters may contain a large number of relatively heterogeneous people.

Once clusters have been defined, they may provide members with personal recommendations. For example, a given person might receive a recommendation to meet the three people “nearest to them” in their cluster, as well as, perhaps, 2 additional people further removed yet still in their cluster. There can be different rules for making recommendations, and machine learning may be used to determine which rules yield the greatest number of successful outcomes. Certain criteria may also be used to structure rules. For example, viewers might first be asked to rate some of their preferences regarding humor. A viewer might express her or his desire to meet “only people who are negative or skeptical toward raunchy humor,” while another viewer might display tolerance for people who are either “neutral toward raunchy humor” or who have expressed no preference. Optionally, people might also express their desire to meet or receive recommendations from people who are “most like me,” “least like me,” or somewhere in between.

After a building a cluster and providing people with recommended introductions, the system then can follow up with users to measure levels of interpersonal interaction. This follow-up represents a way of behaviorally measuring the success of potential matches. The system might also offer the user a direct prompt—for example, “rate how compatible you are with another user in respect to your humor preferences.” In some embodiments, a 7-point scale may be used to grade this compatibility, ranging from extremely compatible to extremely incompatible. Also, a scale might rate the usefulness of system recommendations. This latter direct input data, plus behavioral measures of success such as the duration and frequency of correspondence between linked users, records of the instances when system recommendations are followed, and the like, can then be used to improve the algorithm. This reinforces successful measures while minimizing less successful actions. In summary, an overall system may consist of methods for mapping people into clusters, and, in some cases, showing individuals the clusters to which they have been assigned. In addition, the system may identify people's humor preferences and, based on the identifying, recommend people (or their preferences) for the user to meet from the user's cluster. To these ends, the system may use different kinds of similarity functions and differently weighted combinations of functions. Which functions and weights work best to predict the successful measures can be learned over time, using machine learning, which reinforces the most successful functions while minimizing non-useful actions. In such a way, the system can not only match people and use the matches to entertain and/or to make recommendations (either showing something about the person or recommending people whom the person may want to meet) it can also or point the person to media/content that similarly disposed users enjoyed. In some cases, the types of advertisements placed on a social networking page may be altered in response to this data.

Some embodiments may include sharing the mental state information across a social network. Mental states may be communicated via FACEBOOK™, LINKEDIN™, MYSPACE™, TWITTER™, GOOGLE+™, TUMBLR™, or other social networking sites. Various steps in the flow 100 may be changed in order, repeated, omitted, or the like without departing from the disclosed concepts. Various embodiments of the flow 100 may be included in a computer program product embodied in a non-transitory computer readable medium that includes code executable by one or more processors.

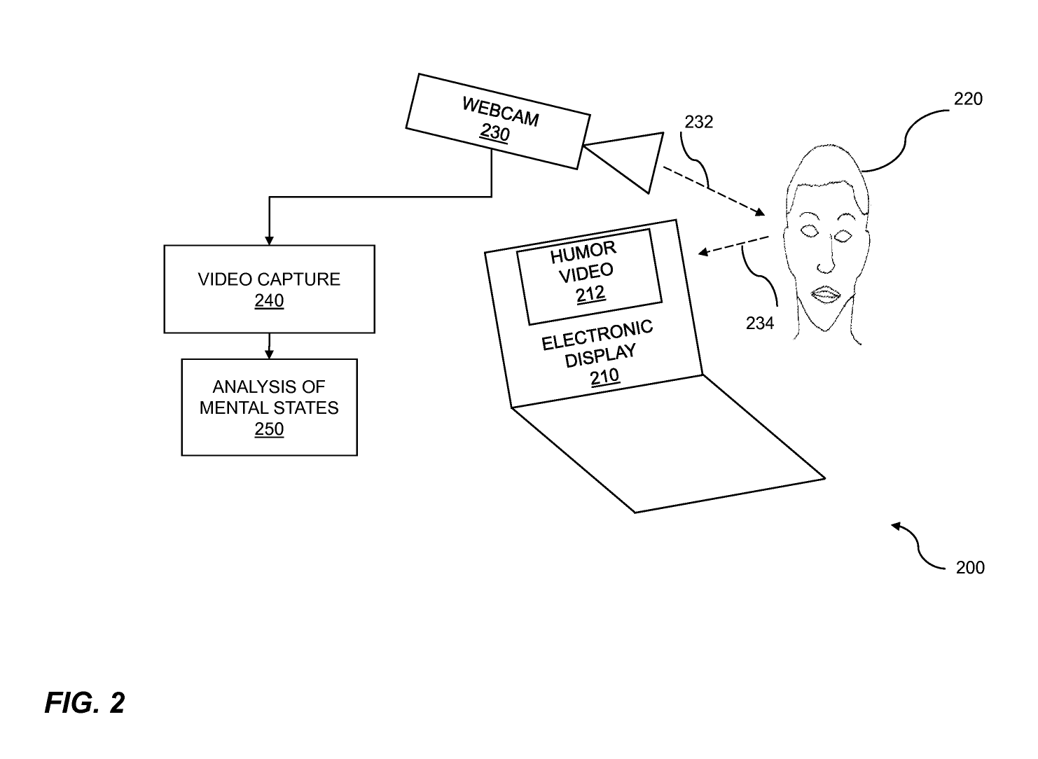

FIG. 2 is a diagram of for capturing facial response to a rendering, particularly where the rendering is humor related. In system 200, an electronic display 210 may show a rendering 212 to a person 220 in order to collect facial data and other indications of mental state. In embodiments, a webcam 230 is used to capture one or more of the facial data and the physiological data. The facial data may include information on facial expressions, action units, head gestures, smiles, smirks, brow furrows, squints, lowered eyebrows, raised eyebrows, or attention, in various embodiments. The webcam 230 may capture video, audio, and still images of the person 220. A webcam, as the term is used herein, may include a video camera, a still camera, a thermal imager, a CCD device, a phone camera, a three-dimensional camera, a depth camera, multiple webcams used to show different views of a person, or any other type of image capture apparatus that may allow data captured to be used in an electronic system. The electronic display 210 may be any electronic display, including but not limited to, a computer display, a laptop screen, a net-book screen, a tablet computer, a cell phone display, a mobile device display, a remote with a display, or some other electronic display. The rendering 212 may be that of a video on a web-enabled application, a trailer, a movie, an advertisement, or some other digital media. The rendering 212 may also include a portion of what is displayed—such as a portion of the media—with the included portion selected either temporally or based on location on the screen. In some cases, a specific character or action can be analyzed to identify how humorous they appear to the individual. In some embodiments the webcam 230 may observe 232 the person to collect facial data. Additionally, the person's or group of people's eyes may be tracked to identify a portion of the rendering 212 on which they are focused. For the purposes of this disclosure, the word “eyes” may refer to either one or both eyes of an individual, or to any combination of one or both eyes of individuals in a group. The eyes may move as the rendering 212 is observed 234 by the person 220. The images of the person 220 from the webcam 230 may be captured by a video capture unit 240. In some embodiments, video may be captured, while in others, a series of still images may be captured. The captured video or still images may be used in one or more analyses.

Analysis of action units, gestures, and mental states 250 may be accomplished using the captured images of the person 220. The action units may be used to identify smiles, frowns, and other facial indicators of mental states. The gestures, including head gestures, may indicate interest or curiosity. For example, a head gesture of moving toward the electronic display 210 may indicate increased interest in the media or desire for clarification. Based on the captured images, analysis of physiological data may be performed. Respiration, heart rate, heart rate variability, perspiration, temperature, and other physiological indicators of mental state can be noted by analyzing the images. So, in various embodiments, a webcam is used to capture one or more of the facial data and the physiological data.

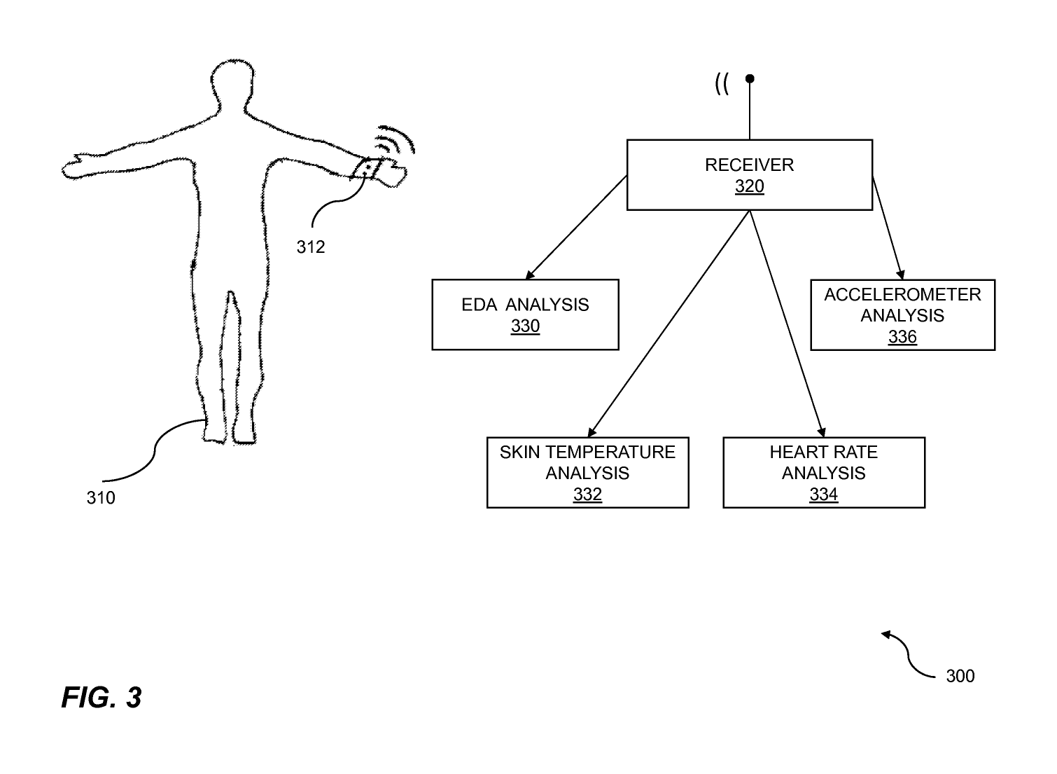

FIG. 3 is a diagram representing physiological analysis. A system 300 may analyze data collected from a person 310 as he or she views various types of comedy. The person 310 may have a biosensor 312 attached to him or her for the purpose of collecting mental state data. The biosensor 312 may be placed on the wrist, palm, hand, head, or other part of the body. In some embodiments, multiple biosensors may be placed on the body in multiple locations. The biosensor 312 may include detectors for physiological data, such as electrodermal activity, skin temperature, accelerometer readings and the like. Other detectors for physiological data may be included as well, such as heart rate, blood pressure, EKG, EEG, further brain waves, to name a few. The biosensor 312 may transmit information collected to a receiver 320 using wireless technology such as Wi-Fi, Bluetooth, 802.11, cellular, or another band. In other embodiments, the biosensor 312 may communicate with the receiver 320 by other methods such as a wired interface, or an optical interface. The receiver may provide the data to one or more components in the system 300. In some embodiments, the biosensor 312 may record multiple types of physiological information in memory for later download and analysis. In some embodiments, the download of recorded physiological data may be accomplished through a USB port or other wired or wireless connection.

Mental states may be inferred based on physiological data, such as physiological data from the sensor 312. Mental states may also be inferred based on facial expressions and head gestures observed by a webcam or a combination of data from the webcam along with data from the sensor 312. The mental states may be analyzed based on arousal and valence. Arousal can range from being highly activated, such as when someone is agitated, to being entirely passive, such as when someone is bored. Valence can range from being very positive, such as when someone is happy, to being very negative, such as when someone is angry. Physiological data may include one or more of electrodermal activity (EDA), heart rate, heart rate variability, skin temperature and respiration, skin conductance or galvanic skin response (GSR), accelerometer readings, and other types of analysis of a human being. It will be understood that both here and elsewhere in this document, physiological information can be obtained either by biosensor 312 or by facial observation via the webcam 230. Facial data may include facial actions and head gestures used to infer mental states. Further, the data may include information on hand gestures or body language and body movements such as visible fidgets. In some embodiments, these movements may be captured by cameras or by sensor readings. Facial data may include the tilting the head to the side, leaning forward, a smile, a frown, as well as many other gestures or expressions.

Electrodermal activity is collected in some embodiments. It may either be collected continuously, every second, four times per second, eight times per second, 32 times per second, or on some other periodic basis. The electrodermal activity may be recorded and stored onto a disk, a tape, flash memory, or a computer system. Additionally, the electrodermal activity may be streamed to a server. The electrodermal activity may be analyzed 330 to indicate arousal, excitement, boredom, or other mental states based on observed changes in skin conductance. Skin temperature may be collected, periodically recorded, and analyzed 332. Changes in skin temperature may indicate arousal, excitement, boredom, or other mental states. Heart rate may be collected and recorded and may also be analyzed 334. A high heart rate may indicate excitement, arousal or another mental state. Accelerometer data may be collected and used to track one, two, or three dimensions of motion. The accelerometer data may be recorded. The accelerometer data may be used to create an actigraph showing an individual's activity level over time. The accelerometer data may be analyzed 336 and may indicate a sleep pattern, a state of high activity, a state of lethargy, or another state. The various data collected by the biosensor 312 may be used along with the facial data captured by the webcam in the analysis of reactions to humor.

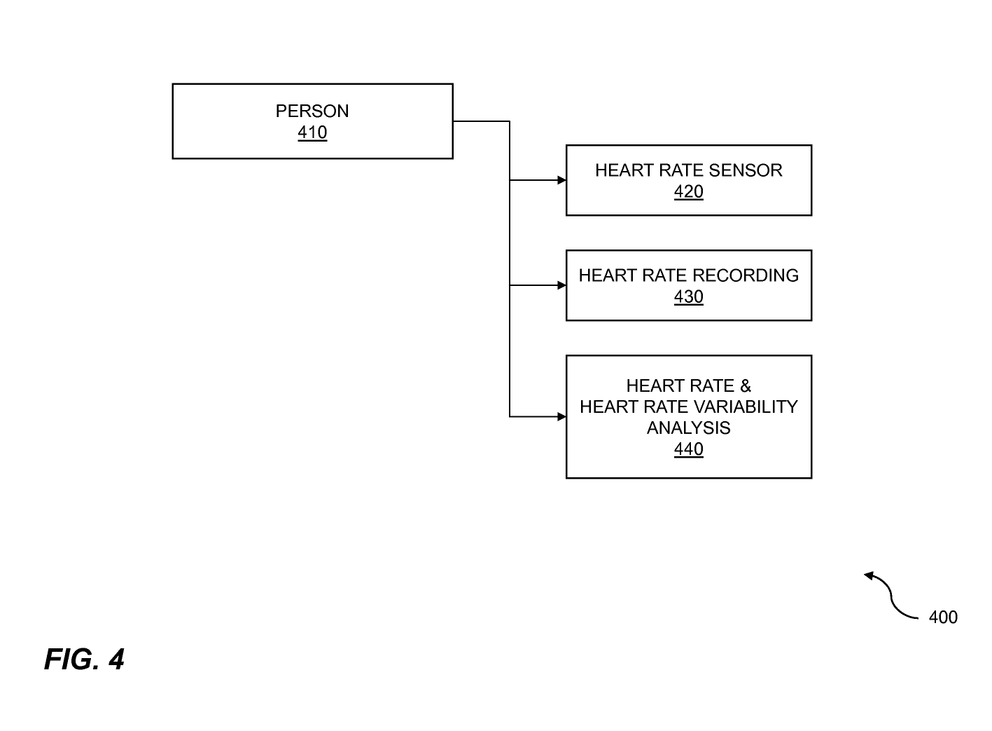

FIG. 4 is a diagram of heart-related sensing while an individual is viewing various forms of comedy. The person 410 is observed by system 400, which may include a biosensor such as a heart rate sensor 420. The observation may come through a contact sensor, through video analysis, or through another method for contactless sensing. Video analysis enables the capture of heart rate information. In some embodiments, a webcam is used to capture the physiological data. In some embodiments, mental states can be inferred from the webcam data. In some embodiments, the physiological data is used to determine autonomic activity, and the autonomic activity may be one of a group comprising electrodermal activity, heart rate, heart rate variability, skin temperature, and respiration. Other embodiments may determine other autonomic activity such as pupil dilation, among others. The heart rate may be recorded 430 to a disk, a tape, flash memory, into a computer system, or streamed to a server, or another data capture device. The heart rate and heart rate variability may be analyzed 440. A lowered heart rate may indicate calmness, boredom, or another mental state or states. Levels of heart-rate variability may be associated with fitness, calmness, stress, and age. The heart-rate variability may be used to help infer the mental state. High heart-rate variability may indicate good health and lack of stress. Low heart-rate variability may indicate an elevated level of stress. Various forms of heart-related analysis may be performed to evaluate a person's response to humor.

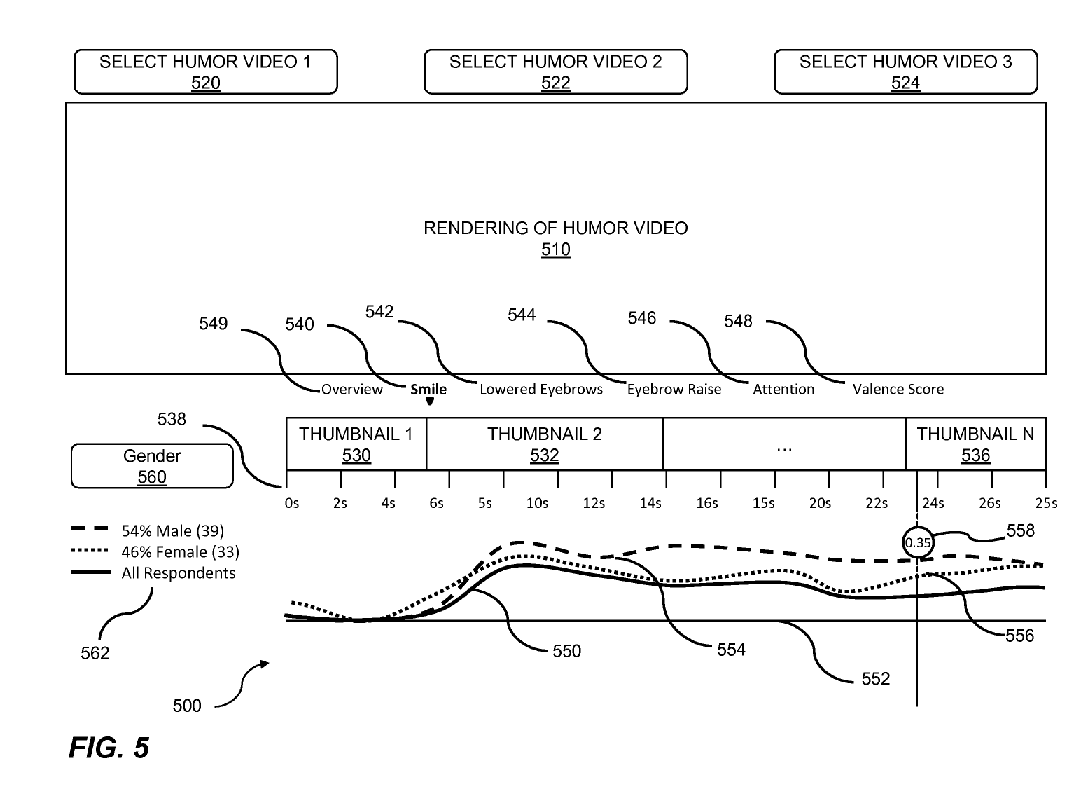

FIG. 5 is a graphical representation of mental state analysis. A window 500 may be shown which includes a rendering of the humor video 510 along with associated mental state information. The rendering in the example shown is a video but may be another rendering in other embodiments. A user may be able to select between a plurality of renderings using various buttons and tabs such as “Select Humor Video 1” button 520, “Select Humor Video 2” button 522, and “Select Humor Video 3” button 524. Various embodiments may have any number of user selections available. A set of thumbnail images for the selected rendering—in the example shown including Thumbnail 1 530, Thumbnail 2 532, through Thumbnail N 536—may be shown below the rendering along with a timeline 538. Some embodiments may not include thumbnails or may have a single thumbnail associated with the rendering. Various embodiments may have thumbnails of equal length while others may have thumbnails of differing lengths. In some embodiments, the start and/or the end of the thumbnails may be determined by editorial cuts in the rendered video while other embodiments may determine a start and/or end of the thumbnails based on changes in the captured mental states of the rendering's viewer/s. In some embodiments, thumbnails showing the subject on whom mental state analysis is being performed may be displayed.

Some embodiments may include the ability for a user to select a particular type of mental state information for display using various buttons or other selection methods. In the embodiment shown, the user has selected the “Smile” button 540, as the smile mental state information is displayed. Other types of mental state information which may be available for user selection in various embodiments may include the “Lowered Eyebrows” button 542, “Eyebrow Raise” button 544, “Attention” button 546, “Valence Score” button 548 or other types of mental state information, depending on the embodiment. The mental state information displayed may be based on physiological data, facial data, actigraphy data, and the like. In some embodiments, an “Overview” button 549 may allow the system to simultaneously display graphs showing multiple types of mental state information.

Because the “Smile” option 540 has been selected in the example shown, a smile graph 550 may be shown against a baseline 552 showing the aggregated smile mental state information of the plurality of individuals from whom mental state data was collected for the rendering 510. A male smile graph 554 and a female smile graph 556 demonstrate a visual representation of aggregated mental state information sorted on a demographic basis. The various demographic-based graphs may be indicated using various line types, as shown, or may be indicated using differing colors or another method of differentiation. A slider 558 may allow a user to select a particular time from the timeline and to see the value of the chosen mental state for that particular time. The slider may be the same line type or color as that of the displayed demographic group.

In some embodiments, various types of demographic-based mental state information can be selected using the demographic button 560. Such demographics may include gender, age, race, income level, or any other type of demographic, including the division of respondents based on their reaction level. A graph legend 562 may be displayed indicating the various demographic groups, the line type or color for each group, the percentage of total respondents and/or absolute number of respondents for each group, and other information about the demographic groups. The mental state information may be aggregated according to the demographic type selected. Based on this and similar types of analysis, an individual's or group of people's responses to humor may be evaluated.

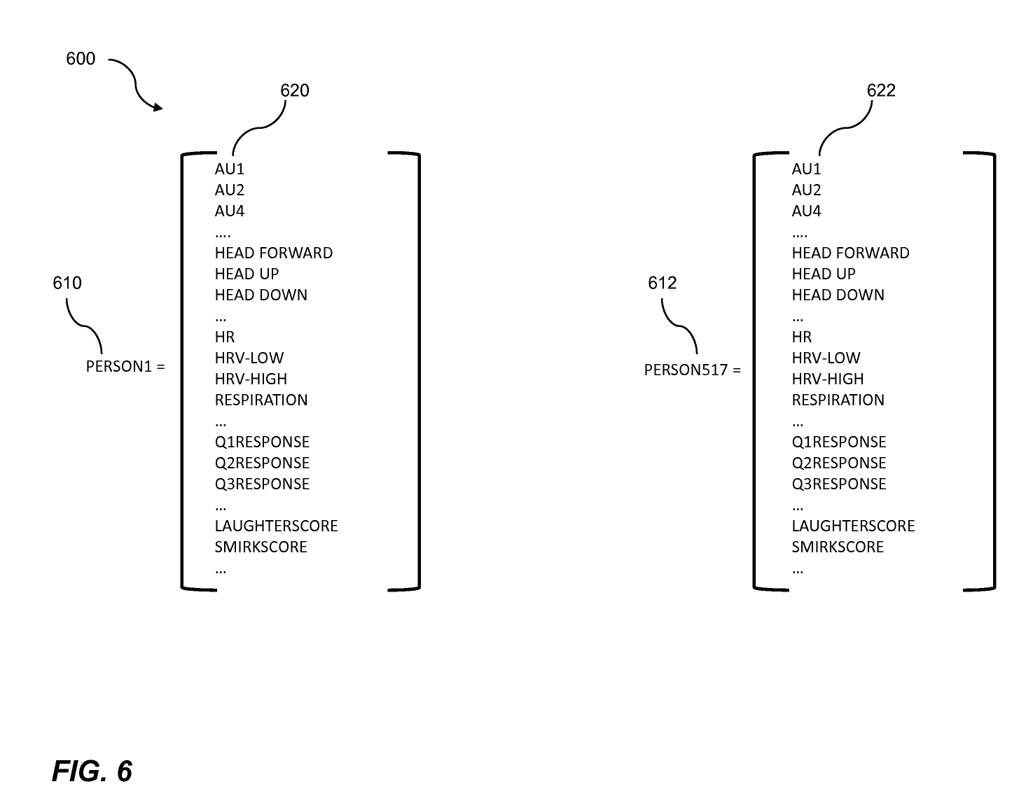

FIG. 6 is an example diagram showing two vectors. Vector representations 600 of data gathered from various persons may be shown. The vector may be based on mental state information obtained from the mental state data where the mental state data may include action units (AU). For a first person, Person1 610, a vector 620 comprising various types of data may be displayed. The data displayed may include action units (for example, AU1, AU2 and AU4), showing head position (for example Head Forward, Head Up, and Head Down) heart rate (HR) response (for example heart rate (HR), heart rate variation low (HRV-Low), heart rate variation high (HRV-High)), Respiration, self-report question responses (for example Q1response, Q2response, Q3response), Laughterscore, Smirkscore, and the like. Any type and amount of collected data may be present in the person vector 620. The values stored in the vector 620 may be binary values (e.g. 1 or 0), probability values, (e.g. a range from 0 to 1), a range of values (e.g. 0 to 1, 0 to 10, 0 to 100, etc.), text values, or any other values appropriate to the purposes of the vector. A second person, in the example shown Person17 612, may have a second vector 622 comprising various types of data. The displayed data vector 622 for the second person Person17 612 may include action units (for example AU1, AU2 and AU4), showing head position (for example Head Forward, Head Up, and Head Down), heart rate (HR) response (for example heart rate (HR), heart rate variation low (HRV-Low), heart rate variation high (HRV-High)), Respiration, self-report question responses, (for example Q1response, Q2response, Q3response), Laughterscore, Smirkscore, and the like. Any type and amount of collected data may be present in the person vector 622. The values stored in the vector 622 may be binary values (e.g. 1 or 0), probability values, (e.g. a range from 0 to 1), a range of values (e.g. 0 to 1, 0 to 10, 0 to 100, etc.), text values, or any other values appropriate to the purposes of the vector. Vectors for the various people may have common data but also may have different data where the common data can be used for comparing results between the people.

The vectors 600 may be used for various identification purposes. The identifying may include generating a vector of mental state data including one or more of facial data, head movement, body position, and self-report results. The identification process may try to pair or group persons with similar or dissimilar preferences, similar or dissimilar answers to self-report questions, and the like. For example, the identifying one or more persons may include identifying those with similar mental states when they are exposed to certain digital media. The certain digital media may include various humor-related videos. Similar mental states could be as simple as smiling at the same time in response to various videos. However, having similar mental states could also be far more nuanced and could include inferring a state of mirthful happiness at the end of a video comprising a humorous story. The identifying may be based on self-reporting. A series of questions about a person's likes and dislikes could be posed, with the person's responses noted. These questions could be presented on digital display, on a mobile device, or on paper to be scanned at a later time. In some embodiments, the one or more persons may be within a social network. The people may be immediately linked through a social network or may be removed by one, two, or some other number of degrees or layers. The identifying may be determined based on the individual's and the one or more persons' responses to the media presentation. The responses could include a mix of smiles and brow furrows at similar times in the media presentation. The identifying may include determining people with a vector close to the individual. Vector analysis may be used to evaluate mental state vectors of multiple people to determine those vectors which are similar and therefore represent similar responses to groups of humorous videos. The identifying may include determining people with a vector distant from the individual. Likewise, vector analysis may be used to find people who are dissimilar. In some cases it will be useful to introduce those who are dissimilar in order to have a more varied interaction or for future evaluations. The mental state data may include smiles, laughter, smirks, and grimaces. The mental state data may include head position, up/down head motion, side-to-side head motion, tilting head motion, body leaning motion, and gaze direction. The media presentation may include one of a group consisting of a movie, a television show, a web series, a webisode, a video, a video clip, an electronic game, an e-book, and an e-magazine. All of this type information, as well as other types of information, may be represented in vector form for analyzing people's reactions to humorous presentations.

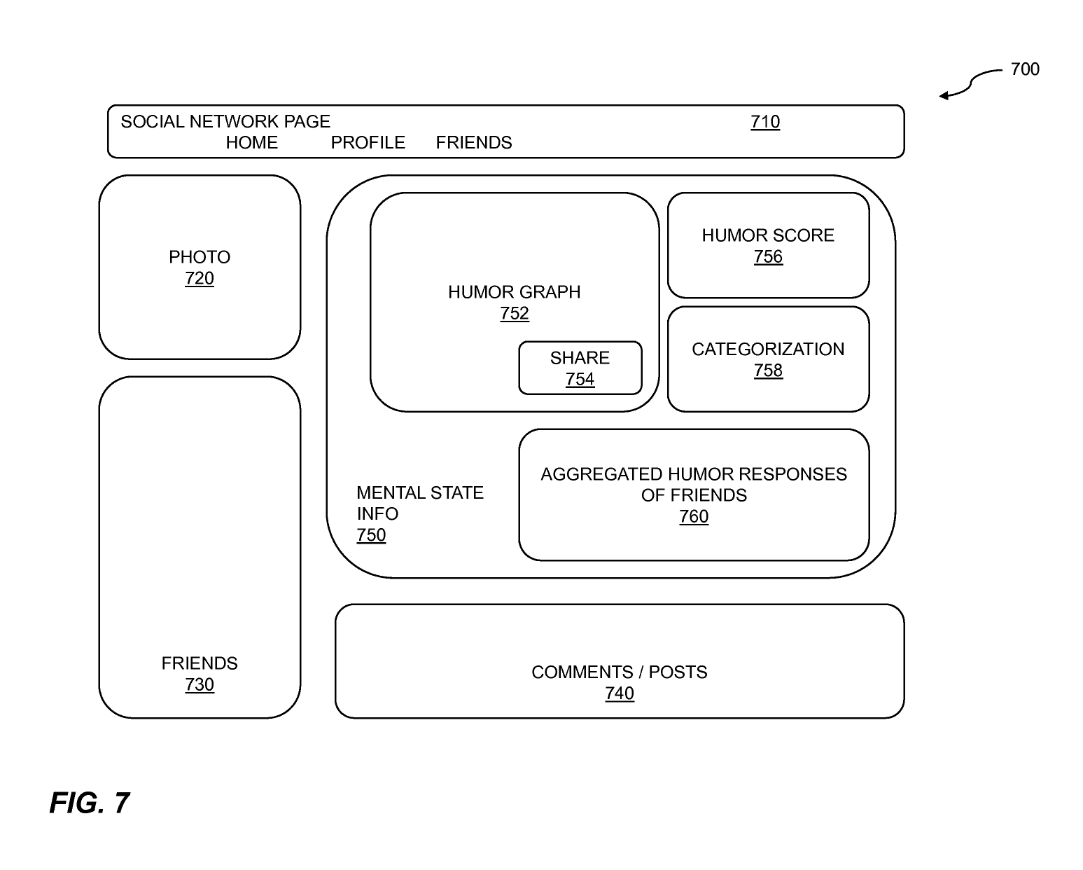

FIG. 7 is an example showing social network page content 700. In embodiments, the scoring of media presentations for humor may be posted to a social network page. The exact content and formatting may vary between various social networks but similar content may be formatted for a variety of social networks including, but not limited to, blogging websites such as TUMBLR™ and social networking sites such as FACEBOOK™, LINKEDIN™, MYSPACE™, TWITTER™, GOOGLE+™, or any other social network. A social network page for a particular social network may include one or more of the components shown in the example of social network page content 700, but may include various other components in place of, or in addition to, the components shown. The example social network page content 700 may include a header 710 which may identify the social network and may include various tabs or buttons for navigating the social network site, such as the “Home,” “Profile,” and “Friends” tabs shown. The social network content 700 may also include a profile photo 720 set by the individual who owns the social network content 700. Various embodiments may include a “friends” list 730 showing the contacts of the individual on the particular social network. Some embodiments may include a comments component 740 to show posts from the individual, friends, or other parties.

The social network page content 700 may include a mental state information section 750. The mental state information section 750 may allow for the posting of mental state information to a social network web page. It may include mental state information which has been shared by the individual or it may include mental state information which has been captured but not yet shared, depending on the embodiment. In at least one embodiment, a humor graph 752 may be displayed, showing the individual's mental state information while viewing a web-enabled application such as a graph or other display. If the information has not yet been shared over the social network, a share button 754 is included in some embodiments. If the individual clicks on the share button 754, then mental state information, such as the humor graph 752 or any of the various summaries of the mental state information, may be shared over the social network. The mental state information may be shared with an individual, a group or subgroup of contacts or “friends,” or another group defined by the social network or the at-large public, depending on the embodiment and the individual's selection. The profile photo 720 or another image shown on the social network may be updated to include an image of the individual with her or his shared mental state information; for example, a smiling picture may be displayed to indicate happy mental state information. In some cases, the image of the individual may be from a period of peak mental state activity. In some embodiments, the photo 720 section or some other section of the social network page content 700 allows for video. Thus, the image may include a video of the individual's reaction or another representation of mental state information. If the mental state information shared is related to a web-enabled application, a reference to the web-enabled application may be forwarded as a part of the sharing of the mental state information and may include a URL and a timestamp, which may indicate a specific point in a video. Other embodiments may include an image of material from the web-enabled application or a video of material from the web-enabled application. The forwarding or sharing of the various mental state information and related items may be done on a single social network, or some items may be forwarded on one social network while other items are forwarded on another social network. In some embodiments, the sharing comprises part of a rating system for the web-enabled application; for example, aggregated mental state information from a plurality of users may be used to automatically generate a rating for videos.

Some embodiments include a humor score 756. A humor score may be assigned to a media presentation for humor based on the mental state data which was collected. In some embodiments, the mental state data is collected over a period of time and the shared mental state information represents a reflection of individual perspective in the form of a humor score 756. The humor score may be a number, a sliding scale, a colored scale, various icons or images representing moods, or any other type of representation. In some embodiments, the individual may be categorized 758 based on reactions to the multiple types of humor.

Some embodiments may aggregate the humor responses of other users 760 where the one or more persons are within a social network, and display these collected responses. The section displaying this collective response may include the aggregated humor response of people shown in the “friends” section 730 who have opted to share their humor response information. Other embodiments may include aggregated humor responses of those friends who have viewed the same web-enabled application as the individual. Further, some embodiments may allow the individual to compare their humor response information as displayed in the humor graph 752 to their friends' humor response information 740. Other embodiments may display various aggregations of different groups.

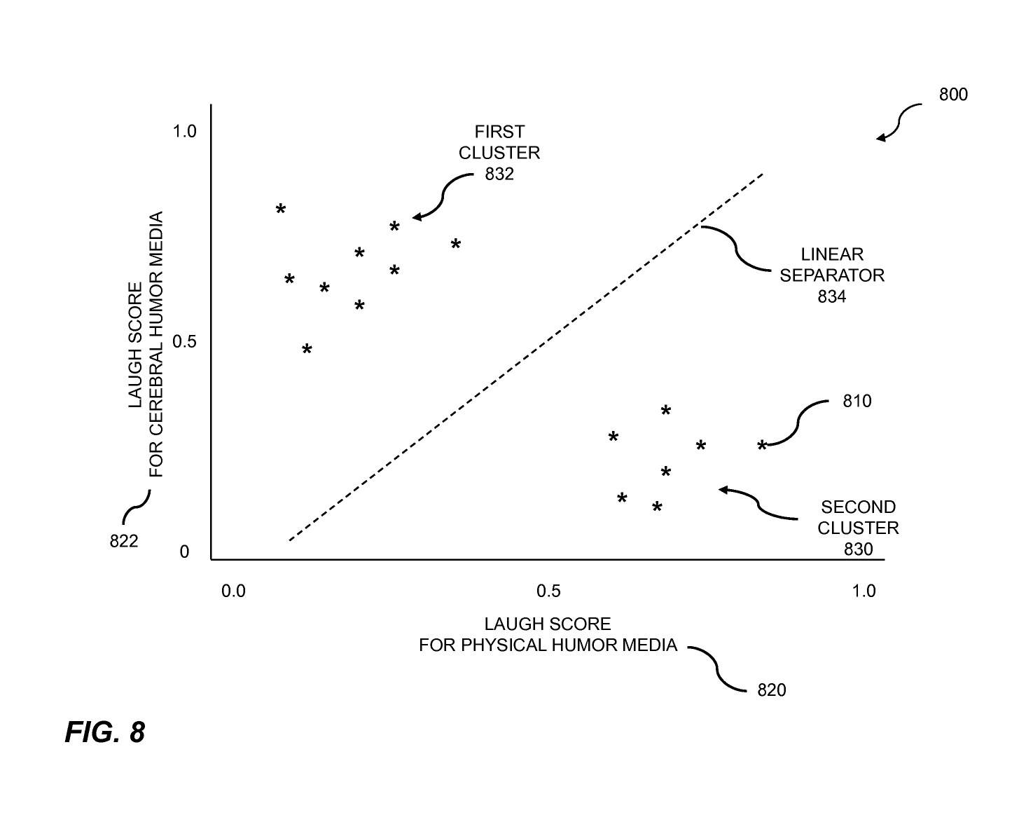

FIG. 8 is a diagram showing an example graph of humor clustering. The example graph 800 is shown with an x-axis 820 and a y-axis 822 each showing values from statistics related to mental states collected. Various statistics may be used for analysis, including probabilities, means, standard deviations, and the like. The statistics shown in graph 800 are shown by way of example rather than limitation. The example statistic shown on the x-axis 820 is for the laugh score detected while different individuals watch a media presentation that emphasizes physical or slapstick type of humor. The laugh score indicates a probability of laughing during the media presentation. Thus, points to the right on the x-axis indicate a larger probability or occurrence of laughing. The y-axis 822 from graph 800 shows a laugh score detected while different individuals watch a media presentation that emphasizes cerebra types of humor. Thus, points higher on the y-axis indicate a larger probability or occurrence of laughing. The units along the axes may be probability or any other appropriate scale familiar to one skilled in the art. In some embodiments, a histogram for each of the laugh scores or other mental state data or mental state information or inferred mental states may be shown. Each point on the diagram may represent how an individual responded to both cerebral types of humor and physical types of humor. Analysis may include clustering an individual with other individuals based on the reactions to multiple types of humor. A point, such as point 810, is for an individual. In the example of point 810, the individual represented laughed more at physical humor than at cerebral humor. An example first cluster 830 is shown for a group of individuals with a preference for cerebral types of humor. An example second cluster is shown for a group of individuals with a preference for physical types of humor. A linear separator 834 may describe the classifier which differentiates between people with a preference for physical types of humor versus those with a preference for cerebral types of humor. The linear separator is an example of a humor classifier. A humor classifier may be based on the one or more humor descriptors. In some embodiments, the linear separator 834 may not perfectly differentiate between the humor preferences for individuals. In some cases there may be a few points for individuals without a specific preference. Statistics may be used to aid in derivation of the classifier and identify a best-fit line separator. When new mental state data is collected, a point may be generated on the graph 800. Based on the location of the point, a preferred type of humor may be evaluated. In this embodiment, the graph 800 is a two dimensional graph, but it should be understood that any number of dimensions may be used to define a classifier and to differentiate between humor preferences. In some embodiments, a very high dimensional classifier may be used. A user and/or computer system may compare various parameters to aid in determining humor preferences. By plotting various mental states of a plurality of viewers, humor preferences may be determined for media. Analysis may include mapping people into clusters. These clusters may be used as an affinity group for types of humor and may be used for recommending people for further association with one another.

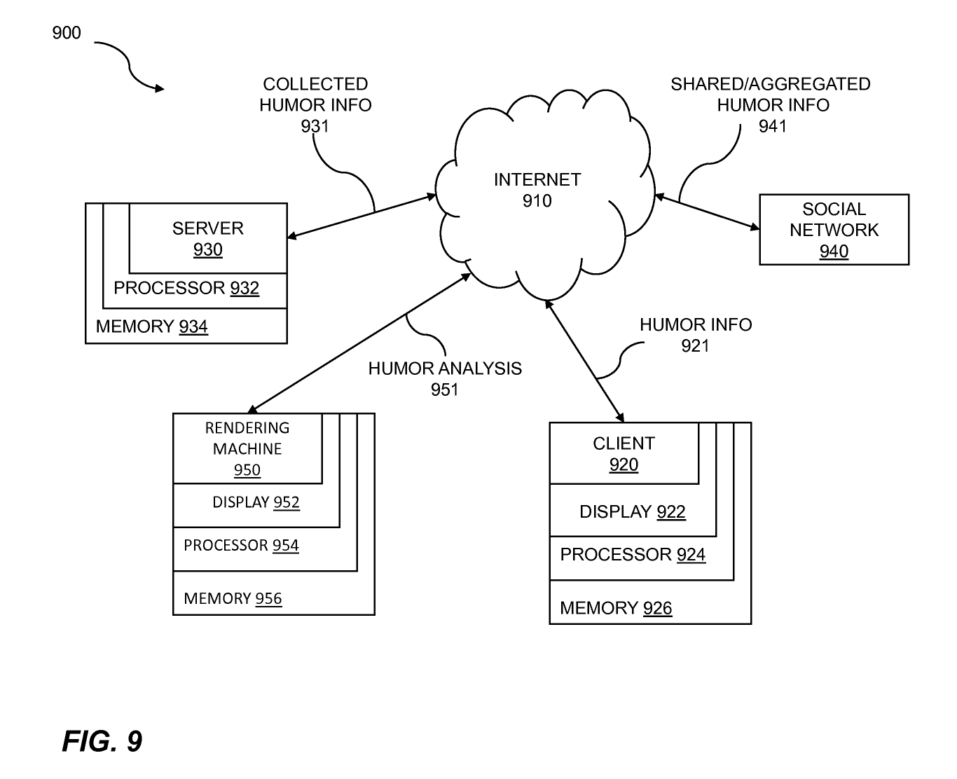

FIG. 9 is a system diagram 900 analyzing mental state data from a humor perspective. The Internet 910, intranet, or other computer network may be used for communication among the various computers. The client computer 920 has a memory 926 which stores instructions, and one or more processors 924 coupled to the memory 929 wherein the one or more processors 924 can execute instructions stored in the memory 929. The memory 929 may be used for storing instructions, mental state data, and videos. The memory 929 may also be used for humor analysis, for system support, and the like. The client computer 920 also may have an Internet connection to carry humor information 921 and a display 922 that may present various renderings to a user. The client computer 920 may be able to collect humor data from an individual or a plurality of people as they view media presentations. In some embodiments, there may be multiple client computers 920 which may each collect humor data from one person or a plurality of people as they interact with a video. The client computer 920 may communicate with the server 930 over the Internet 910, some other computer network, or by other methods suitable for communication between two or more computers. In some embodiments, the server 930 functionality may be embodied in the client computer.

The server 930 may have an Internet connection for receiving collected humor information 931 and have a memory 934 which stores instructions and one or more processors 932 attached to the memory 934 to execute instructions. The server 930 may receive various types of humor information, collected from a plurality of people as they view media presentations on the client computer 920 or computers. Further, the server may analyze the humor data and produce humor information. The server 930 may also aggregate humor information gathered from the plurality of people who view the media presentations. The server 930 may also associate the aggregated humor information with both the rendering and the collection of norms for the context being measured. In some embodiments, the server 930 may allow individual users to view and evaluate the humor information associated with the videos, but in other embodiments, the server 930 may distribute the shared or aggregated humor information across a computer network by sending mental state information 941 to a social network 940 to be shared across the social network 940. In some embodiments the social network 940 may run on the server 930.

Some embodiments include a rendering machine 950. The rendering machine includes one or more processors 954 coupled to memory 956 to store instructions, and a display 952. The display 952 may be any electronic display, including but not limited to, a computer display, a laptop screen, a net-book screen, a tablet screen, a cell phone display, a mobile device display, a remote with a display, a television, a projector, or the like. The rendering machine 950 may receive humor analysis 951 based on mental state data collected while humor material is being viewed and analysis performed on the mental state data to infer mental states.

The system 900 may perform a computer-implemented method for mental state analysis comprising: collecting mental state data of an individual as the individual is exposed to a media presentation; and sending the mental state data, which was collected, for inferring mental states based on the mental state data which was collected wherein the mental states include reactions to multiple types of humor and analyzing the reactions to the multiple types of humor to identify one or more preferred types of humor. The system 900 may perform a computer-implemented method for mental state analysis comprising: receiving mental state data, collected from an individual as the individual is exposed to a media presentation; inferring mental states based on the mental state data which was collected wherein the mental states include reactions to multiple types of humor; and analyzing the reactions to the multiple types of humor to identify one or more preferred types of humor. The system 900 may perform a computer-implemented method for mental state analysis comprising: receiving an analysis of reactions to multiple types of humor wherein the analysis is used to identify one or more preferred types of humor based on mental state data collected from an individual as the individual is exposed to a media presentation and wherein mental states are inferred based on the mental state data which was collected; and rendering an output based on the analysis which was received.

The system 900 may include computer program product embodied in a non-transitory computer readable medium for mental state analysis comprising code for collecting mental state data of an individual as the individual is exposed to a media presentation, code for analyzing the mental state data to produce mental state information, code for inferring mental states based on the mental state data which was collected wherein the mental states include reactions to multiple types of humor, and code for analyzing the reactions to the multiple types of humor to identify one or more preferred types of humor.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for mental state analysis comprising:
collecting mental state data of an individual as the individual is exposed to a media presentation;
inferring mental states based on the mental state data which was collected wherein the mental states include reactions to multiple types of humor; and
analyzing the reactions to the multiple types of humor to identify one or more preferred types of humor.

2. The method of claim 1 wherein the multiple types of humor are included in the media presentation.

3. The method of claim 1 wherein the media presentation includes a series of videos.

4. The method of claim 3 wherein the series of videos represent the multiple types of humor.

5. The method of claim 3 further comprising categorizing the individual based on the reactions to the multiple types of humor.

6. The method of claim 3 further comprising clustering the individual with other individuals based on the reactions to multiple types of humor.

7. The method of claim 6 wherein the other individuals are exposed to the series of videos.

8. The method of claim 1 wherein the multiple types of humor include one of slapstick comedy, romantic comedy, cerebral comedy, raunchy comedy, political comedy, noir comedy, dry comedy, physical comedy, and satirical comedy.

9. The method of claim 1 wherein the multiple types of humor include one or more of Republican bashing, Democrat bashing, conservative humor, liberal humor, family-rated humor, adult-rated humor, humor involving cats, humor involving dogs, and humor involving babies.

10. The method of claim 1 wherein the inferring of mental states further includes one or more of a group including frustration, confusion, disappointment, hesitation, cognitive overload, focusing, being engaged, attending, boredom, exploration, confidence, trust, delight, and satisfaction.

11. The method of claim 1 further comprising identifying one or more persons based on the mental states which were inferred.

12. The method of claim 11 wherein the identifying one or more persons includes identifying those with similar mental states.

13. The method of claim 11 wherein the one or more persons are within a social network.

14. The method of claim 11 wherein the identifying is determined based on responses by the individual and the one or more persons to the media presentation.

15. The method of claim 14 wherein the identifying is further a function of self-reporting.

16. The method of claim 11 wherein the identifying is based on mapping people into clusters.

17. The method of claim 11 wherein the identifying includes generating a vector of mental state data including one or more of facial data, head movement, body position, and self-report results.

18. The method of claim 17 wherein the identifying includes determining people with a vector close to the individual.

19. The method of claim 17 wherein the identifying includes determining people with a vector distant from the individual.

20. The method of claim 19 wherein the analyzing the reactions to the multiple types of humor further comprises identifying a type of humor which the individual finds to be funny.

21. The method of claim 19 wherein the analyzing the reactions to the multiple types of humor further comprises identifying a type of humor which the individual is averse.

22. The method of claim 1 wherein the mental state data includes smiles, laughter, smirks, and grimaces.

23. The method of claim 1 wherein the mental state data includes head position, up/down head motion, side-to-side head motion, tilting head motion, body leaning motion, and gaze direction.

24. The method of claim 1 further comprising scoring the media presentation for humor based on the mental state data which was collected.

25. The method of claim 24 further comprising posting the scoring to a social network page.

26. The method of claim 24 further comprising using the scoring for introducing people.

27. The method of claim 24 further comprising making recommendations for other media based on personal preferences of other individuals with similar mental states.

28. The method of claim 24 further comprising determining which advertisements are shown to the individual.

29. The method of claim 1 wherein the mental state data includes one or more of a group including physiological data, facial data, and actigraphy data.

30. The method of claim 29 wherein the physiological data includes one or more of electrodermal activity, heart rate, heart rate variability, skin temperature, and respiration.

31. The method of claim 29 wherein a webcam is used to capture one or more of the facial data and the physiological data.

32. The method of claim 1 wherein the media presentation includes one of a group consisting of a movie, a television show, a web series, a webisode, a video, a video clip, an electronic game, an e-book, and an e-magazine.

33. The method of claim 1 further comprising analyzing the mental state data to produce mental state information.

34. A computer-implemented method for mental state analysis comprising:
collecting mental state data of an individual as the individual is exposed to a media presentation; and
sending the mental state data, which was collected, for inferring mental states based on the mental state data which was collected wherein the mental states include reactions to multiple types of humor and analyzing the reactions to the multiple types of humor to identify one or more preferred types of humor.

35. A computer-implemented method for mental state analysis comprising:
receiving mental state data, collected from an individual as the individual is exposed to a media presentation;
inferring mental states based on the mental state data which was collected wherein the mental states include reactions to multiple types of humor; and
analyzing the reactions to the multiple types of humor to identify one or more preferred types of humor.

36. A computer-implemented method for mental state analysis comprising:
receiving an analysis of reactions to multiple types of humor wherein the analysis is used to identify one or more preferred types of humor based on mental state data collected from an individual as the individual is exposed to a media presentation and wherein mental states are inferred based on the mental state data which was collected; and
rendering an output based on the analysis which was received.

37. A computer program product embodied in a non-transitory computer readable medium for mental state analysis, the computer program product comprising:
code for collecting mental state data of an individual as the individual is exposed to a media presentation;
code for analyzing the mental state data to produce mental state information;
code for inferring mental states based on the mental state data which was collected wherein the mental states include reactions to multiple types of humor; and
code for analyzing the reactions to the multiple types of humor to identify one or more preferred types of humor.

38. A system for mental state analysis comprising:
a memory for storing instructions;
one or more processors attached to the memory wherein the one or more processors are configured to:
collect mental state data of an individual as the individual is exposed to a media presentation;
analyze the mental state data to produce mental state information;
infer mental states based on the mental state data which was collected wherein the mental states include reactions to multiple types of humor; and
analyze the reactions to the multiple types of humor to identify one or more preferred types of humor.
